(19) United States
(12) Patent Application Publication
(10) Pub. No.: US 2013/0176101 A1
(43) Pub. Date: Jul. 11, 2013

(54) METHOD FOR TRANSMITTING DATA OF AND TO AN AUTOMATIC CHUCKING MACHINE

(71) Applicant: Förster Technik GmbH, Engen (DE)

(72) Inventors: Thomas Förster, Bodman-Ludwigshafen (DE); Markus Straub, Hufingen (DE)

(73) Assignee: Förster Technik GmbH, Engen (DE)

(21) Appl. No.: 13/660,617

(22) Filed: Oct. 25, 2012

(30) Foreign Application Priority Data
Oct. 25, 2011 (DE) 102011054771.1

(51) Int. Cl. G05B 13/02

(52) U.S. Cl. CPC G05B 13/02
USPC 340/3.1

(57) ABSTRACT

A method for transmitting data from and to an automatic feeder, such as an automatic watering device. The data can be stored on a storage medium. A system for transmitting data from and to an automatic feeder is also disclosed.

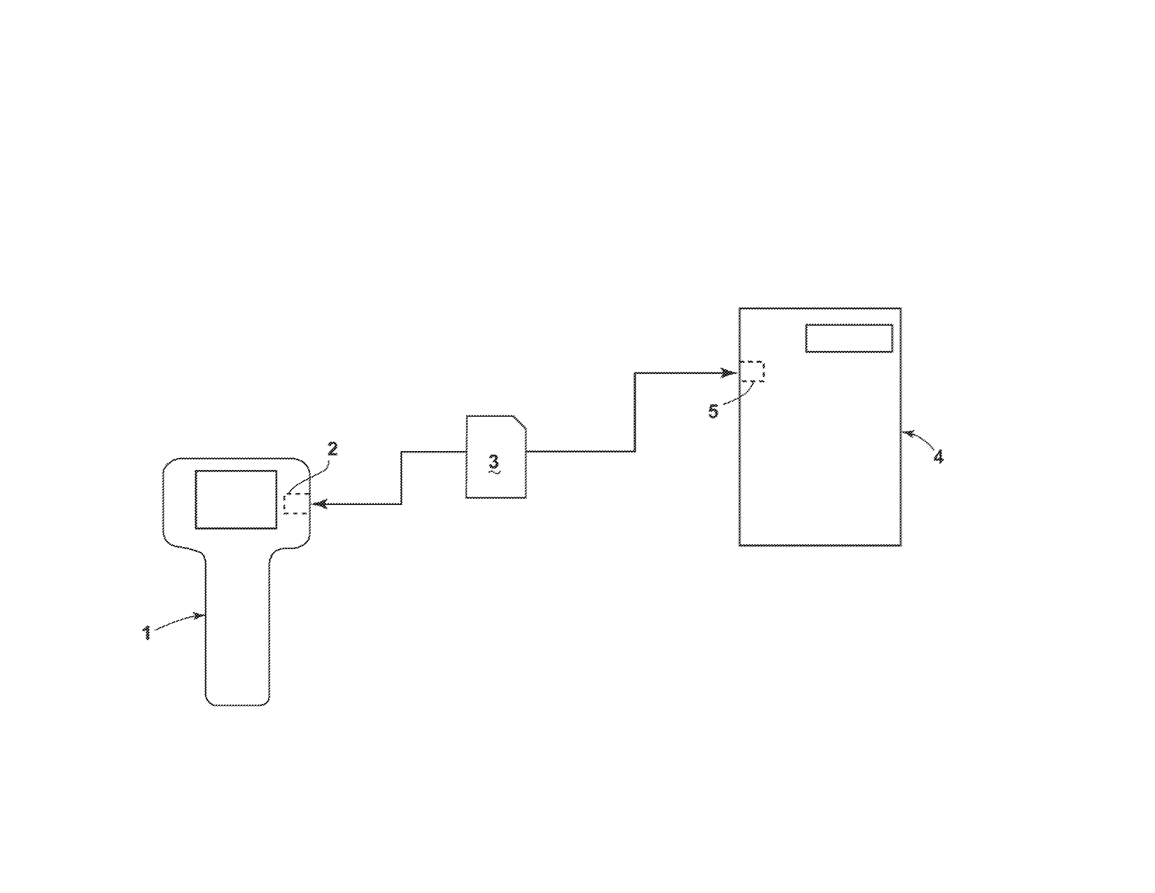

The invention relates to a method for transmitting data from and to an automatic feeder, particularly an automatic watering device, as well as a corresponding installation.

### PRIOR ART

Automatic feeders for animals are known in a variety of shapes and designs. They are used for the precisely controlled dispensing of feed but also for the monitoring of the individual animals for their feed intake habits. Even the dispensing of medical products in conjunction with the feed can be taken over by the automatic device.

Accordingly, for example, DE 10 2006 037 082 shows a method for operating an automatic mixing device for the preparation of liquid foodstuff for animals, a preset quantity of liquid foodstuff being mixed in the automatic mixing device.

Moreover, DE 10 2008 047 754 B3 shows a device and a method for supplying animals with foodstuffs having a mixing container that is connected to an extraction device. The mixing container is connected to other extraction devices via a dispensing device. As a result, different groups of animals can be supplied with foodstuff.

### Problem

It is the object of the present invention to substantially improve and to facilitate the transmission of data from and to an automatic feeder.

### Solution of the problem

This object is achieved by storing the data on a storage medium.

Worthy of consideration as the storage medium are, above all, all easy-to-handle memories such as, for example, flash memories, USB sticks, transponders or SD cards. These storage media offer the advantage that they are easy to handle, for example to send, and nonetheless have a large storage capacity.

The range of application of the present invention is extraordinarily varied. For one, a program can be transmitted through the storage medium to the automatic feeder by means of which the automatic feeder is controlled overall. Updates for the software can then also be transmitted later. Moreover, a data backup, i.e., a securing of the data can be performed using the storage medium. In other words, intensive communication takes place between the user of the automatic watering device and, for example, the manufacturer or program creator and administrator.

The storage medium is also intended to provide to the manufacturer information on the status of the automatic device. For example, the manufacturer can determine how long the automatic device has already been in use, how much foodstuff it has already dispensed and when it needs to be serviced and that parts need to be replaced and when. Breakdowns of the automatic device can thus be prevented.

The manufacturer can also determine with which menus the user works over time and what functions of the automatic device are used in particular. From this, the manufacturer can draw conclusions for the development and improvement of the automatic devices.

This reading in and reading out of data, for example of program data, backup or update data generally occurs in an appropriate processor having a means for accommodating the storage medium.

A possibility for the reading out and reading in of data from and to the storage medium is also provided on the automatic device itself. There are many possibilities for achieving this, including a separate reading device with or without cables, an accommodation on the automatic device itself, or the like. In today's automatic feeders, a handheld reader (handheld) is provided in many cases which now, according to the invention, has an accommodation for the storage medium. Data can then be read out from the card by the automatic device but also transmitted to the card. These can be, for example, data loggers for error analysis containing performance data of the device, or data for process documentation. Moreover, data loggers for all animals and device data are conceivable, including, for example, for animal history, animal behavior, feeding behavior, etc., for analysis in the PC.

Other data that are to be transmitted can be animal management data. For example, watering schedules with appropriate device settings can be prepared on the processor and transmitted via the storage medium. Vice versa, data on the drinking behavior, breeding history, feed intake, etc., are stored on the automatic device on the storage medium and analyzed on the PC using an external program.

Animal management also includes external management software that can be used, for example, by consultants, farmers or sales partners.

Furthermore, the storage medium also serves as a network for several automatic devices, so that a plurality or group of automatic devices can be controlled and updated via a single storage medium.

Besides these general fields of application, the storage medium can also be of benefit to experts. The actual user, particularly the farmer, maintains contact to experts through the storage medium, which the farmer achieves, for example, by supplying the storage medium or its contents in any manner, for example via the Internet, to a panel of experts that can analyze the data present on the storage medium. This advantage benefits not only farmers but sales partners or consultants as well.

The panel of experts then determines the most suitable specifications for the setup of the automatic watering device based on the data present on the storage medium which can then be re-transmitted by the farmer or consultant to the automatic watering devices. These data refer, for example, to the milk powder used, as well as to breed of calf, breeding goal and even the desired environmental conditions for the animal depending on the season.

An analysis tool for analyzing animal parameters is also provided, however, that enables experts to then make suggestions for custom adjustments.

The advantages of the easy-to-handle storage medium consist in the fact that, for one, a common standard technology is used that does not require any special hardware. No permanent network or Internet connection is necessary, and the automatic watering device need not be connected to a PC or network. The use of the storage medium only requires simple handling for end clients, and without special knowledge. Data handling and processing, remote diagnosis and analysis is possible with a single interface.

Even third-party information is conceivable, for example through the insertion of advertisement.

Not every function of the storage medium is intended to be offered at no charge; it is conceivable, particularly in relation to the obtaining of information from the abovementioned panel of experts, that the user has to unlock this function using a registration code after paying a certain financial consideration.

### DESCRIPTION OF THE FIGURES

Further advantages, features and details of the invention follow from the following description of preferred sample embodiments as well as on the basis of the drawing; the sole FIGURE shows a schematic representation of an installation for transmitting data from and to an automatic feeder.

This automatic feeder is not depicted in detail, but only a handheld reader (handheld) 1 that can be connected to the automatic feeder either directly at wirelessly. This handheld 1 has a slot 2 for accommodating an SD card 3 on which any kind of data can be stored.

Moreover, a processor 4 is provided for the installation according to the invention which likewise has another slot 5 for accommodating the SD card 3.

The present invention functions as follows:

In order to transmit any data to the automatic feeder, the storage medium 3 is pushed into the slot 5 of the processor 4 and the data are stored on the SD card or read out from the SD card 3.

After the storage medium 3 has then reached the owner of the automatic feeder, they can insert the storage medium 3 into the slot 2 of the handheld 1 and read out data from the SD card 3 and transfer it from the automatic feeder to the storage medium.

### LIST OF REFERENCE SYMBOLS

1 handheld
2 slot
3 SD card
4 processor
5 slot

1-8. (canceled)

9. A method for transmitting data from and to an automatic feeder, the method comprising:
storing data on a storage medium.

10. The method of claim 9, wherein said automatic feeder comprises an automatic watering device.

11. The method of claim 9, wherein the data is transferred from a processor to the storage medium and read by the storage medium.

12. The method of claim 9, including a handheld reader, wherein the handheld reader is configured for association with said automatic feeder, and data is transferred to the storage medium.

13. The method of claim 12, wherein data is read from the storage medium.

14. The method of claim 9, wherein the storage medium is used for transferring data concerning one or more of the following: an animal behavior, an animal history, and feeding schedule.

15. The method of claim 9, wherein the storage medium is used to secure data.

16. The method of claim 9, wherein information on the storage medium provides status information associated with the automatic feeder.

17. The method of claim 16, wherein the status information comprises one or more of the following: how long the feeder has been in use, how much foodstuff has been dispensed, when the feeder needs to be serviced, that parts need to be replaced, and when parts need to be replaced.

18. The method of claim 16, wherein the storage medium comprises a flash memory, a USB stick, a transponder, or an SD card.

19. A system for transmitting data from and to an automatic feeder, the system comprising:
an automatic feeder; and
at least one storage medium associated with said automatic feeder.

20. The system of claim 19, wherein the automatic feeder comprises an automatic watering device.

21. The system of claim 19, including a handheld device, and the handheld device is configured for data transfer with respect to the automatic feeder.

22. The system of claim 19, wherein the automatic feeder, a handheld device associated with the automatic feeder, or both the feeder and a handheld device have an accommodation or receiving portion for the storage medium.

23. The system of claim 19, including a processor with an accommodation or receiving portion for the storage medium.

24. The system of claim 23, wherein the processor is configured for the further transmission of data.

25. The method of claim 19, wherein information on the storage medium provides status information associated with the automatic feeder.

26. The method of claim 25, wherein the status information comprises one or more of the following: how long the feeder has been in use, how much foodstuff has been dispensed, when the feeder needs to be serviced, that parts need to be replaced, and when parts need to be replaced.

27. The method of claim 19, wherein the storage medium comprises a flash memory, a USB stick, a transponder, or an SD card.
